(19) United States
(12) Patent Application Publication
(10) Pub. No.: US 2026/0037072 A1
(43) Pub. Date: Feb. 5, 2026

(54) IMU- and EMG-Based Extended Reality Input Device and Method

(71) Applicants: Hyundai Motor Company, Seoul (KR); Kia Corporation, Seoul (KR)

(72) Inventors: Hoseung Cha, Hwaseong-Si (KR); Seungkyu Nam, Hwaseong-Si (KR); Taejun Lee, Hwaseong-Si (KR)

(21) Appl. No.: 18/980,238

(22) Filed: Dec. 13, 2024

(30) Foreign Application Priority Data
Aug. 5, 2024 (KR) 10-2024-0103756

(51) Int. Cl. G06F 3/01; G06F 3/0346

(52) U.S. Cl. CPC G06F 3/017; G06F 3/015; G06F 3/0346

(57) ABSTRACT

An IMU- and EMG-based extended reality input device is provided to be connected to an arm band worn on an arm of a user and provided with an inertial measurement unit (IMU) sensor and an electromyography (EMG) sensor and an extended reality module worn on a face of the user and providing a virtual extended reality, through a network, and configured to dispose a virtual cursor on the extended reality, the virtual cursor moving corresponding to a change of an angle and position change of the arm of the user detected by an IMU sensor and providing an input corresponding to a gesture of the arm of the user recognized through an EMG sensor.

### CROSS-REFERENCE TO RELATED APPLICATION

The present application claims priority to Korean Patent Application No. 10-2024-0103756 filed Aug. 5, 2024, the entire contents of which are incorporated herein by reference for all purposes.

### TECHNICAL FIELD

The present disclosure relates to an inertial measurement unit (IMU) and electromyography (EMG)-based extended reality input device and method. More particularly, the present disclosure relates to an IMU- and EMG-based extended reality input device and method that simultaneously utilizes IMU signals and EMG signals.

### BACKGROUND

Extended reality is an umbrella term that includes virtual reality (VR), augmented reality (AR), and mixed reality (MR). In extended reality, input is done using a controller. Some VR and AR controls may mainly use controllers that require use of hands. However, controllers that require use of hands create a disconnection from the surrounding environment and hinder natural interaction environments. To solve these problems, gesture input technology using cameras attached to AR/VR devices may be used.

However, camera-based gesture input technology requires multiple camera sensors positioned in various directions to cover various positions of the hand, and has the disadvantage that the recognition rate is reduced depending on the surrounding environment (light, camera angle, or the like).

In addition, some EMG-based interfaces may have the disadvantage of being able to perform only registered gestures and pre-mapped commands.

### SUMMARY

The present disclosure attempts to provide an IMU- and EMG-based extended reality input device and method capable of utilizing an IMU-based efficient 3D pointing method and simultaneously using an EMG-based command transfer function using artificial intelligence, and thereby providing an expanded usage environment than the environment where only one of them is used.

An apparatus may comprise: a first wearable device comprising an inertial measurement unit (IMU) sensor and an electromyography (EMG) sensor, wherein the first wearable device is configured to detect, based on a movement of a body part of a user, at least one IMU signal and at least one EMG signal, and wherein the body part comprises a forearm of the user and a hand of the user; and a second wearable device configured to: receive, from the first wearable device via a communication interface, the at least one IMU signal and the at least one EMG signal; display a virtual cursor on an extended reality display, wherein the virtual cursor is configured to move based on the at least one IMU signal, and wherein the at least one IMU signal corresponds to an orientation change of the forearm and a position change of the forearm; and determine, based on the at least one EMG signal, an input corresponding to a gesture of the hand of the user.

The virtual cursor may be implemented as a virtual ray that is associated with an orientation of the forearm and with a direction of the forearm, and the first wearable device may comprise an arm band.

An object on a virtual space in the extended reality display may be identified through a ray-casting technique utilizing the virtual ray.

The apparatus may further comprise: at least one processor; and memory storing instructions that, when executed by the at least one processor, cause the apparatus to: map position information between the IMU sensor and the virtual cursor; select an object on a virtual space associated with the extended reality display by utilizing an EMG-based gesture input; and process a command associated with a target object, recognized by virtual the cursor, on the extended reality display.

The instructions, when executed by the at least one processor, may cause the apparatus to map three-dimensional coordinates with respect to a position and orientation of the forearm to the virtual cursor of a virtual ray shape.

The second wearable device may be configured to provide a plurality of different inputs based on a plurality of commands corresponding to a plurality of gestures, wherein each of the plurality of different inputs corresponds to one of the plurality of commands, respectively, and wherein at least one of the plurality of gestures is determined based on the at least one EMG signal.

The plurality of commands may comprise a selection command corresponding to a first gesture of the plurality of gestures, an activation command corresponding to a second gesture of the plurality of gestures, a third command corresponding to a third gesture of the plurality of gestures, a menu command corresponding to a fourth gesture of the plurality of gestures, and a voice recognition command corresponding to a fifth gesture of the plurality of gestures.

The second wearable device may be configured to identify different gestures, among the plurality of gestures, via an EMG signal processing associated with an artificial intelligence model.

The second wearable device may be configured to, based on a type of an object indicated by the virtual cursor, transmit different commands with respect to a same gesture or transmit a same command with respect to different gestures.

The second wearable device may be configured to display a plurality of outputs corresponding to a plurality of inputs on a virtual space associated with the extended reality display.

A method performed by an apparatus may comprise: receiving at least one inertial measurement unit (IMU) signal and at least one electromyography (EMG) signal, wherein the at least one IMU signal is generated based on an inertial measurement unit (IMU) sensor, and wherein the at least one EMG signal is generated based on an EMG sensor; determining, based on the at least one IMU signal, a position of a forearm of a user and an orientation of the forearm; mapping the determined position and orientation of the forearm to position information of a cursor displayed on a virtual space in a display; identifying, based on the at least one EMG signal, a gesture of a hand of the user; and determining, based on the identified gesture, an input associated with an object on the virtual space, wherein the object corresponds to the cursor.

The method may further comprise: generating a plurality of objects and the cursor on the virtual space, wherein the generating the cursor comprises implementing, as the cursor, a virtual ray that is associated with an orientation of the forearm and with a direction of the forearm.

The method may further comprise identifying the object on the virtual space through a ray-casting technique utilizing the virtual ray.

The method may further comprise processing a command associated with a target object, identified by the cursor, on the display implementing extended reality.

The mapping may comprise: determining three-dimensional coordinates with respect to the forearm; and mapping the three-dimensional coordinates to the cursor implemented as the virtual ray.

The method may further comprise determining a plurality of different inputs based on a plurality of commands corresponding to a plurality of gestures, wherein each of the plurality of different inputs corresponds to one of the plurality of commands, respectively, and wherein at least one of the plurality of gestures is determined based on the at least one EMG signal.

The plurality of commands may comprise a selection command corresponding to a first gesture of the plurality of gestures, an activation command corresponding to a second gesture of plurality of gestures, a third command corresponding to a third gesture of plurality of gestures, a menu command corresponding to a fourth gesture of plurality of gestures, and a voice recognition command corresponding to a fifth gesture of plurality of gestures.

The method may further comprise identifying different gestures, among the plurality of gestures, via an EMG signal processing associated with an artificial intelligence model.

The method may further comprise based on a type of an object indicated by the cursor, transmitting different commands with respect to a same gesture or transmitting a same command with respect to different gestures.

The method may further comprise displaying a plurality of outputs corresponding to a plurality of inputs on the virtual space.

An IMU- and EMG-based extended reality input device and method according to an example may provide a fully hands-free input that is not limited to a measurement environment and not limited to physical controllers.

An IMU- and EMG-based extended reality input device and method according to an example may provide high interface expandability by utilizing a IMU-based ray-casting technique and combining EMG-based various gesture input function.

### BRIEF DESCRIPTION OF THE DRAWINGS

FIG. 1 shows an example of an IMU- and EMG-based extended reality input system according to an example.

FIG. 2 shows an example of a block diagram of an IMU- and EMG-based extended reality input device according to an example.

FIG. 3 shows an example of a block diagram of an IMU- and EMG-based extended reality input device according to an example.

FIG. 4 shows an example flowchart of an IMU- and EMG-based extended reality input method according to an example.

FIG. 5 shows an example of a signal flowchart for explaining an IMU- and EMG-based extended reality input method according to an example.

FIG. 6 shows an example of an input screen through an IMU- and EMG-based extended reality input method according to an example.

FIG. 7 shows an example of a drawing for explaining a computing device according to an example.

### DETAILED DESCRIPTION

An example of the disclosure will be described more fully hereinafter with reference to the accompanying drawings such that a person skill in the art may easily implement the example. As those skilled in the art would realize, the described examples may be modified in various different ways, all without departing from the spirit or scope of the present disclosure. In order to clarify the present disclosure, parts that are not related to the description will be omitted, and the same elements or equivalents are referred to with the same reference numerals throughout the specification.

The term “and/or” is used to include all instances of any combination of multiple items being the subject. For example, “A and/or B” includes all three cases: “A”, “B”, and “A and B”. Using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software. Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Hereinafter, examples of the present disclosure will be described with reference to the drawings.

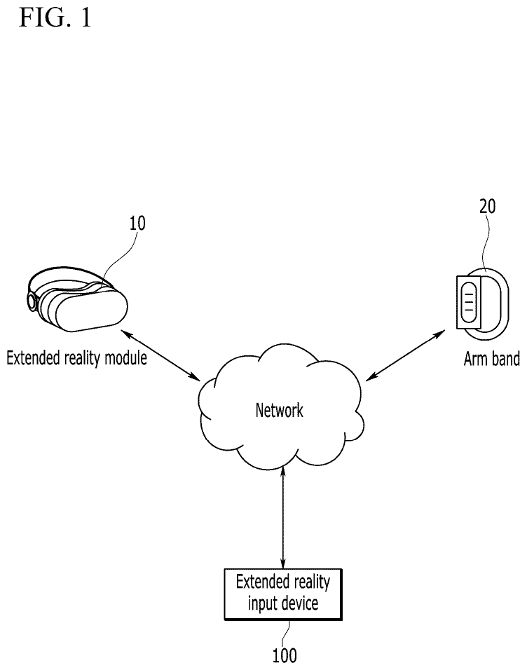

FIG. 1 shows an example of an IMU- and EMG-based extended reality input system according to an example.

Referring to FIG. 1, the IMU- and EMG-based extended reality input system may include an extended reality module 10, an arm band 20, and an IMU- and EMG-based extended reality input device 100.

Extended reality (XR) may include virtual reality (VR), augmented reality (AR) and/or mixed reality (MR).

The extended reality module 10 may include a virtual reality module, an augmented reality module, and/or a mixed reality module. The extended reality module 10 may be one of the virtual reality module, the augmented reality module, or the mixed reality module.

The extended reality module 10 may include hardware and software components that enable implementation and/or experience of extended reality.

The extended reality module 10 may provide a virtual space to a user. The virtual space may be a virtual space enabling virtual reality, augmented reality or mixed reality experience.

The extended reality module 10 may include a head-mounted display (HMD), a computer, and/or a controller.

The head-mounted display may be used for providing virtual reality, augmented reality, or mixed reality experience, and may include a high-resolution display, a processing unit, and/or various sensor.

The controller may be an input device that helps the user interact with the virtual environment. The controller may be implemented as the arm band 20 and the IMU- and EMG-based extended reality input device 100.

The extended reality module 10 may be connected to the arm band 20 and the IMU- and EMG-based extended reality input device 100 through a network.

The arm band 20 may be worn on an arm of the user, and may include an inertial measurement unit (IMU) sensor and an electromyography (EMG) sensor.

For example, an IMU sensor may comprise a device that may measure and/or report a body's specific force, angular rate, and/or magnetic field, using a combination of accelerometers, gyroscopes, and/or magnetometers. The IMU sensor may track an object's movement and orientation in 3D space, providing data on acceleration, rotation, and sometimes direction. IMUs may be useful in applications requiring precise motion tracking and stability, such as in smartphones, drones, virtual reality systems, and/or autonomous vehicles, etc. By integrating this motion data, IMUs may enable devices to navigate, stabilize, and interact with their environment more effectively.

For example, an EMG sensor may a device used to detect and/or measure the electrical activity produced by muscles during contraction. If a muscle is activated, it generates small electrical signals that may be captured by EMG sensors, which may be typically placed on the skin's surface above the muscle or, for example, inserted directly into the muscle tissue.

By translating muscle activity into electrical signals, EMG sensors may provide a powerful tool for analyzing and/or utilizing human movement in various applications.

The arm band 20 may calculate an angle and/or position of the arm of the user through the IMU sensor. The arm band 20 may recognize various gestures of the arm of the user through the EMG sensor. The arm band 20 may recognize a gesture of the user based on changes in electromyography due to contraction of muscles of the arm of the user.

The gesture may include various types of motions of the arm or hand of the user. For example, the gesture may include the user's making a fist, bending a particular finger, or the like.

As described herein, the IMU- and EMG-based extended reality input device 100 may be hereinafter referred to as the extended reality input device 100.

The extended reality input device 100 may be connected to the extended reality module 10 and the arm band 20 through a network.

The extended reality input device 100 may receive sensor signals from the arm band 20, and provide an input to the virtual space provided through the extended reality module 10.

The input may include controlling of extended reality and selection of an object on a virtual space, or the like.

The extended reality input device 100 may utilize a ray-casting interaction technique utilizing an IMU signal and simultaneously utilize an EMG signal-based gesture input technology, to provide various types of inputs.

For example, a ray-casting interaction technique may comprise a method used in computer graphics and 3D environments to determine the location and interaction of objects by projecting a virtual ray from a specific point, such as a camera or a user's perspective, in a certain direction. This technique may involve sending a straight line, or ray, into the scene to detect if it intersects with any objects. If a ray collides with an object, the system may calculate details like the distance, position, and surface properties at the collision point.

The ray-casting interaction technique may support an interaction between a user and a virtual object in a virtual reality (VR) and augmented reality (AR) environment. The ray-casting interaction may be used if the user points or selects a specific point in the virtual space, and may enable interaction with the object by projecting a virtual ray in a direction indicated by the controller or the hand of the user.

As described herein, the virtual ray parallel to the arm of the user mounted with the IMU sensor may be projected as a cursor for an input to the virtual space.

The extended reality input device 100 may dispose the cursor moving corresponding to a change of the detected angle and position of the arm of the user on the virtual space through the IMU sensor of the arm band 20.

For example, the cursor may be implemented as the virtual ray parallel to an angle and direction of the arm of the user on which the arm band 20 is mounted.

The extended reality input device 100 may recognize an object on the virtual space through a ray-casting technique utilizing the virtual ray.

The extended reality input device 100 may provide various forms of inputs corresponding to a gesture of an arm of the user detected through the EMG sensor of the arm band 20.

For example, the extended reality input device 100 may provide an input of clicking a target object recognized by the cursor according to the gesture of the arm of the user.

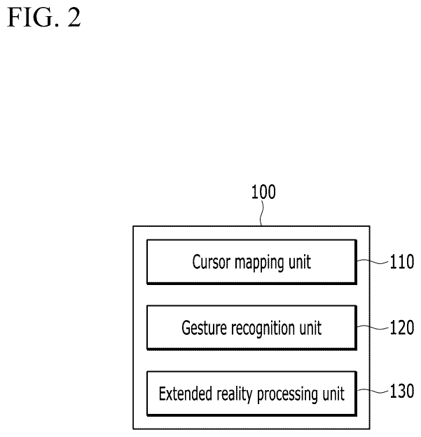

FIG. 2 shows an example block diagram of the IMU- and EMG-based extended reality input device according to an example.

Referring to FIG. 2, the extended reality input device 100 may include a cursor mapping unit 110, a gesture recognition unit 120 and an extended reality processing unit 130.

The cursor mapping unit 110 may map position information between the IMU sensor and the cursor.

The cursor mapping unit 110 may map 3-dimensional coordinates with respect to a position and angle of the arm received through the IMU sensor to the cursor of a virtual ray shape.

The gesture recognition unit 120 may select the object on the virtual space by utilizing an EMG-based gesture input.

The gesture recognition unit 120 may provide a plurality of different inputs through a plurality of commands corresponding to a plurality of gestures, respectively.

The plurality of commands may include a selection command corresponding to a first gesture, an activation command corresponding to a second gesture, a reset command corresponding to a third gesture, a home command corresponding to the third gesture, a menu command corresponding to a fourth gesture, and/or a voice recognition command corresponding to a fifth gesture.

The gesture recognition unit 120 may distinguish and recognize different gestures among the plurality of gestures through an EMG signal processing using an artificial intelligence.

The gesture recognition unit 120 may transmit different commands with respect to the same gesture or transmit the same command with respect to different gestures, depending on the type of object indicated by the cursor.

The extended reality processing unit 130 may reflect the target object recognized by the cursor to the extended reality.

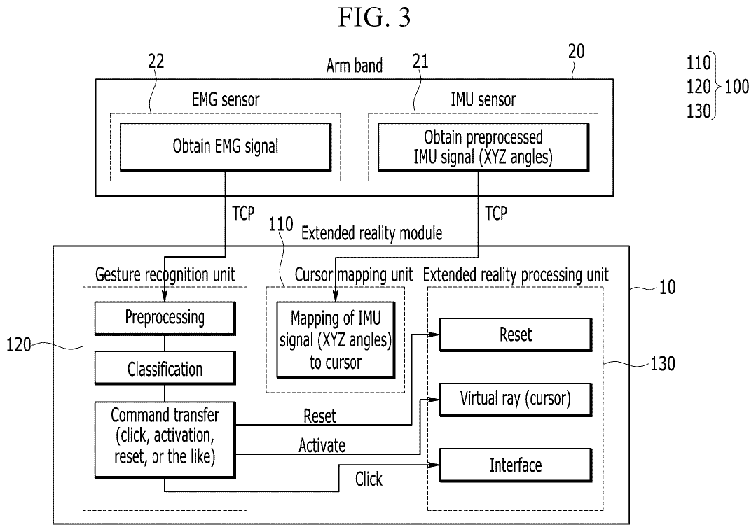

The extended reality processing unit 130 may display a plurality of outputs corresponding to a plurality of inputs and the plurality of inputs on the virtual space. FIG. 3 shows an example block diagram of the IMU- and EMG-based extended reality input device according to an example.

FIG. 3 shows the arm band 20, the extended reality module 10, and the extended reality input device 100 included in the extended reality module 10.

The extended reality input device 100 may be implemented to be included in the extended reality module 10 as the controller of the extended reality module 10.

In FIG. 3, the arm band 20 may obtain a preprocessed IMU signal with respect to the position and angle of the arm of the user through the IMU sensor 21. The preprocessed IMU signal may appear as 3-dimensional coordinates of XYZ.

The arm band 20 may obtain the EMG signal generated according to the gesture of the arm of the user through the EMG sensor 22.

The IMU signal and the EMG signal may be transmitted to the extended reality input device 100 through a TCP protocol. The extended reality input device 100 may be included inside a head-mounted display or a computer server of the extended reality module 10.

The cursor mapping unit 110 may receive the preprocessed IMU signal of 3-dimensional coordinates from the IMU sensor 21 and map it to the cursor.

The gesture recognition unit 120 may receive and preprocess the EMG signal from the EMG sensor 22.

The gesture recognition unit 120 may classify the preprocessed EMG signal and generate a plurality of different commands. The gesture recognition unit 120 may classify the plurality of commands based on the EMG signals generated for respective recognized gestures.

For example, the commands may include a click, an activation, a reset, or the like.

The gesture recognition unit 120 may transfer the classified commands to the extended reality processing unit 130.

The extended reality processing unit 130 may reflect an input due to a command received from the gesture recognition unit 120 to the extended reality.

The extended reality processing unit 130 may activate the cursor implemented as the virtual ray on the virtual space.

The extended reality processing unit 130 may reset the cursor in order to compensate the position of the cursor offset due to the accumulated error of the IMU signal.

The extended reality processing unit 130 may select the virtual object on the virtual space. The virtual object may appear as an interface. The extended reality processing unit 130 may perform a click command with respect to a virtual interface icon implemented on the virtual space.

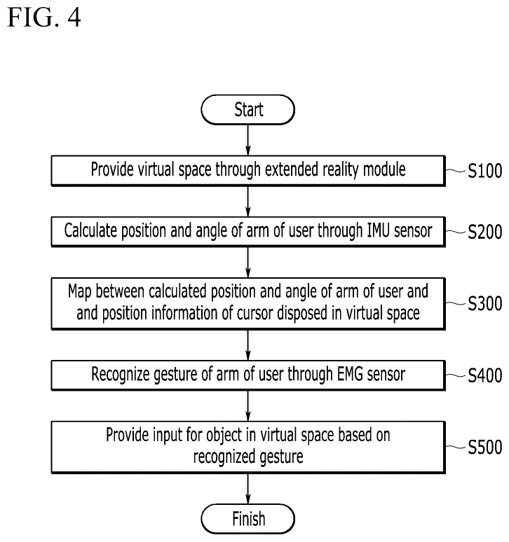

FIG. 4 shows an example flowchart of an IMU- and EMG-based extended reality input method according to an example. The IMU- and EMG-based extended reality input method of FIG. 4 may be performed through the extended reality input device 100 of FIG. 2 or FIG. 3.

In FIG. 4, at step S100, the extended reality module 10 (see FIG. 1) may provide the virtual space. The extended reality module 10 (see FIG. 1) may generate a plurality of objects on the virtual space.

The extended reality input device 100 may generate the plurality of objects and the cursor on the virtual space.

The extended reality input device 100 may implement the virtual ray parallel to the angle and direction of the arm of the user as the cursor through the IMU sensor.

The extended reality input device 100 may recognize the object on the virtual space through a ray-casting technique utilizing the virtual ray.

At step S200, the extended reality input device 100 may calculate the position and angle of the arm of the user through the IMU sensor.

At step S300, the extended reality input device 100 may map the calculated position and angle of the arm of the user and position information of the cursor disposed on the virtual space.

The extended reality input device 100 may calculate 3-dimensional coordinates with respect to the arm through the IMU sensor, and may map the calculated 3-dimensional coordinates to the cursor implemented as the virtual ray.

At step S400, the extended reality input device 100 may recognize the gesture of the arm of the user through the EMG sensor.

At step S500, the extended reality input device 100 may provide an input with respect to the object on the virtual space based on the recognized gesture.

The extended reality input device 100 may provide the plurality of different inputs through the plurality of commands corresponding to the plurality of gestures, respectively.

The plurality of commands may include the selection command corresponding to the first gesture, the activation command corresponding to the second gesture, the reset command corresponding to the third gesture, the home command corresponding to the third gesture, the menu command corresponding to the fourth gesture, and the voice recognition command corresponding to the fifth gesture.

The extended reality input device 100 may distinguish and recognize different gestures among the plurality of gestures through an EMG signal processing using an artificial intelligence.

The extended reality input device 100 may learn a plurality of gestures and commands corresponding to the EMG signal through machine-learning or deep learning, and may generate an artificial intelligence model for distinguishing different gestures.

The extended reality input device 100 may provide various types of inputs without a physical button the artificial intelligence model for distinguishing different gestures.

The artificial intelligence model may perform learning based on the IMU signal and the EMG signal, and commands and transmission result data transmitted corresponding thereto. According to the learning, the artificial intelligence model may distinguish and recognize the IMU signal and EMG signal-based gesture, and transmit an appropriate command.

For example, the extended reality input device 100 may transmit different commands with respect to the same gesture or transmit the same command with respect to different gestures, depending on the type of object indicated by the cursor.

The extended reality input device 100 may transmit a first command if the cursor has recognized a first object at the time when the first gesture is input, but if the cursor has recognized a second object at the time when the same first gesture is input, may transmit a second command.

Additionally or alternatively, if the cursor has recognized the second object, the extended reality input device 100 may transmit the same third command even if any one of the first gesture to the third gesture is input.

The extended reality input device 100 may reflect the target object recognized by the cursor to the extended reality. The target object recognized by the cursor may be represented as having been recognized in the extended reality.

The extended reality input device 100 may display the plurality of outputs corresponding to the plurality of inputs on the virtual space.

If the reset command is input, the extended reality input device 100 may reset the cursor. If the home command is input, the extended reality input device 100 may display an initial screen of the menu in the extended reality.

If the voice recognition command due to a specific gesture is input, the extended reality input device 100 may connect to a voice recognition system in the extended reality.

If the menu command is input, the extended reality input device 100 may display a menu screen for providing an interface to various functions.

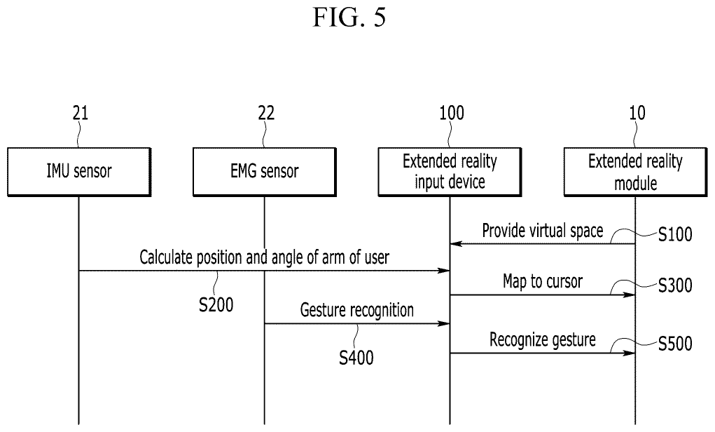

FIG. 5 shows an example of a signal flowchart for explaining an IMU- and EMG-based extended reality input method according to an example. FIG. 5 shows a signal flow in the IMU- and EMG-based extended reality input method of FIG. 4.

In FIG. 5, at step S100, the extended reality module 10 may generate the virtual space, and provide the virtual space providing the input of the extended reality input device 100.

At step S200, the IMU sensor 21 may calculate the position and angle of the arm of the user, and provide them to the extended reality input device 100 as 3-dimensional coordinates.

At step S300, the extended reality input device 100 may map the received 3-dimensional coordinates to a virtual cursor displayed by the extended reality module 10.

At step S400, the EMG sensor 22 may recognize the gesture of the arm of the user, and provide the EMG signal to the extended reality input device 100.

At step S500, the extended reality input device 100 may classify or analyze the EMG signal by using an artificial intelligence, and may transmit a command for an input to the extended reality module 10.

The extended reality module 10 may display the plurality of outputs corresponding to the plurality of inputs on the virtual space.

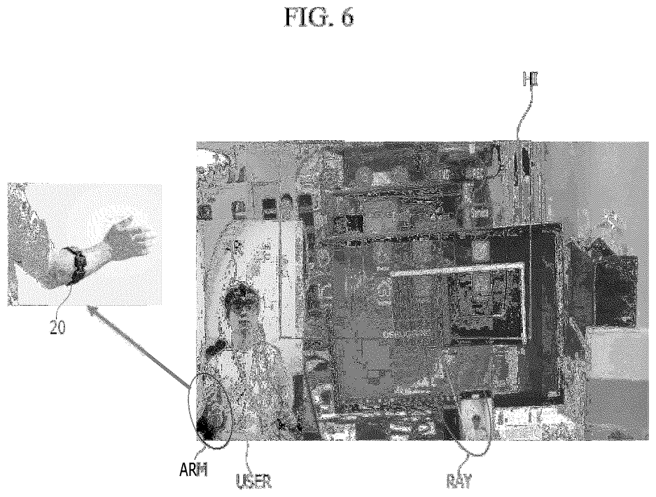

FIG. 6 shows an example input screen through an IMU- and EMG-based extended reality input method according to an example.

FIG. 6 shows an example user and an example arm, ARM of the user wearing an augmented reality module AR and the arm band 20.

In FIG. 6, the user may gaze a screen where augmented reality is implemented through the augmented reality module AR. A virtual home interface HI including the plurality of objects may be provided on the augmented reality screen.

The arm band 20 may be worn on the arm, ARM of the user. The arm, ARM of the user and a cursor RAY in the form of a virtual ray of the augmented reality screen appears parallel to each other.

The user may move the arm, ARM to move the cursor RAY, which is the input means. The cursor RAY may move parallel to the arm of the user according to the IMU signal provided from the arm band 20.

An IMU- and EMG-based extended reality input device is provided to be connected to an arm band worn on an arm of a user and provided with an inertial measurement unit (IMU) sensor and an electromyography (EMG) sensor and an extended reality module worn on a face of the user and providing a virtual extended reality, through a network, and configured to dispose a virtual cursor on the extended reality, the virtual cursor moving corresponding to a change of an angle and position change of the arm of the user detected by an IMU sensor and providing an input corresponding to a gesture of the arm of the user recognized through an EMG sensor.

The cursor may be implemented as a virtual ray parallel to an angle and direction of the arm of the user equipped with the arm band.

An object on a virtual space may be recognized through a ray-casting technique utilizing the virtual ray.

The IMU- and EMG-based extended reality input device may include a cursor mapping unit configured to map position information between the IMU sensor and the cursor, a gesture recognition unit configured to select an object on a virtual space by utilizing an EMG-based gesture input, and an extended reality processing unit configured to reflect a target object recognized by the cursor to the extended reality.

The cursor mapping unit may be configured to map 3-dimensional coordinates with respect to a position and angle of the arm received through the IMU sensor to the cursor of a virtual ray shape.

The gesture recognition unit may be configured to provide a plurality of different inputs through a plurality of commands corresponding to a plurality of gestures, respectively.

The plurality of commands may include a selection command corresponding to a first gesture, an activation command corresponding to a second gesture, a reset command corresponding to a third gesture, a home command corresponding to the third gesture, a menu command corresponding to a fourth gesture, and a voice recognition command corresponding to a fifth gesture.

The gesture recognition unit may be configured to distinguish and recognize different gestures among the plurality of gestures through an EMG signal processing using an artificial intelligence.

The gesture recognition unit may be configured to transmit different commands with respect to the same gesture or transmit the same command with respect to different gestures, depending on the type of object indicated by the cursor.

The extended reality processing unit may be configured to display a plurality of outputs corresponding to a plurality of inputs on the virtual space.

An IMU- and EMG-based extended reality input method may include calculating a position and angle of an arm of a user through an IMU sensor, mapping the calculated position and angle of the arm of the user and position information of a cursor disposed on a virtual space, recognizing a gesture of the arm of the user through an EMG sensor, and providing an input with respect to an object on the virtual space based on the detected gesture.

The IMU- and EMG-based extended reality input method may further include generating a plurality of objects and the cursor on the virtual space, and the generating the cursor may include implementing a virtual ray moving parallel to an angle and direction of the arm of the user as the cursor by using the IMU sensor.

The IMU- and EMG-based extended reality input method may further include recognizing the object on the virtual space through a ray-casting technique utilizing the cursor.

The IMU- and EMG-based extended reality input method may further include reflecting a target object recognized by the cursor to the extended reality.

The mapping the position information of the cursor may include calculating 3-dimensional coordinates with respect to the arm through the IMU sensor, and mapping the calculated 3-dimensional coordinates to the cursor implemented as the virtual ray.

The providing the input with respect to the object on the virtual space based on the gesture may include providing a plurality of different inputs through a plurality of commands corresponding to a plurality of gestures, respectively.

The plurality of commands may include a selection command corresponding to a first gesture, an activation command corresponding to a second gesture, a reset command corresponding to a third gesture, a home command corresponding to the third gesture, a menu command corresponding to a fourth gesture, and a voice recognition command corresponding to a fifth gesture.

The detecting the gesture of the arm of the user may include distinguishing and recognizing different gestures among the plurality of gestures through an EMG signal processing utilizing an artificial intelligence.

The detecting the gesture of the arm of the user may further include transmitting different commands with respect to the same gesture or transmitting the same command with respect to different gestures, depending on the type of object indicated by the cursor.

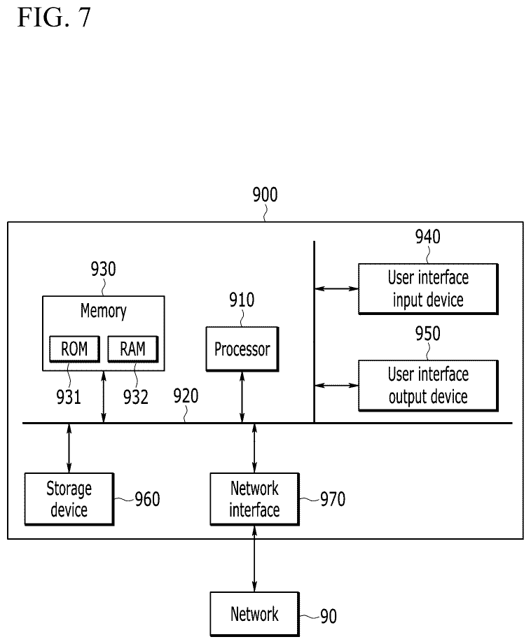

The IMU- and EMG-based extended reality input method may further include displaying a plurality of outputs corresponding to a plurality of inputs on the virtual space. FIG. 7 shows an example drawing for explaining a computing device according to an example.

Referring to FIG. 7, the IMU- and EMG-based extended reality input device and method according to examples may be implemented by using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 6.

The memory 930 and the storage device 960 may include various types of volatile or non-volatile storage media. For example, the memory may include read-only memory (ROM) 931 and a random-access memory (RAM) 932. In this example, the memory 930 may be located inside or outside processor 910, and the memory 930 may be connected to the processor 910 through various known means.

For example, at least some configurations or functions of the IMU- and EMG-based extended reality input device and method according to an example may be implemented as a program or software executable by the computing device 900, and program or software may be stored in a computer-readable medium.

For example, at least some components or functions of the IMU- and EMG-based extended reality input device and method according to the examples may be implemented using hardware or circuitry of the computing device 900, or implemented using a separate device that may be electrically connected to the computing device 900.

While this disclosure has been described in connection with what is presently considered to be practical examples, it is to be understood that the disclosure is not limited to the disclosed examples, but, on the contrary, is intended to cover various modifications and equivalent arrangements included within the spirit and scope of the appended claims.

What is claimed is:

1. An apparatus comprising:
a first wearable device comprising an inertial measurement unit (IMU) sensor and an electromyography (EMG) sensor, wherein the first wearable device is configured to detect, based on a movement of a body part of a user, at least one IMU signal and at least one EMG signal, and wherein the body part comprises a forearm of the user and a hand of the user; and
a second wearable device configured to:
receive, from the first wearable device via a communication interface, the at least one IMU signal and the at least one EMG signal;
display a virtual cursor on an extended reality display, wherein the virtual cursor is configured to move based on the at least one IMU signal, and wherein the at least one IMU signal corresponds to an orientation change of the forearm and a position change of the forearm; and
determine, based on the at least one EMG signal, an input corresponding to a gesture of the hand of the user.

2. The apparatus of claim 1, wherein the virtual cursor is implemented as a virtual ray that is associated with an orientation of the forearm and with a direction of the forearm, and wherein the first wearable device comprises an arm band.

3. The apparatus of claim 2, wherein an object on a virtual space in the extended reality display is identified through a ray-casting technique utilizing the virtual ray.

4. The apparatus of claim 1, further comprising:
at least one processor; and
memory storing instructions that, when executed by the at least one processor, cause the apparatus to:
map position information between the IMU sensor and the virtual cursor;
select an object on a virtual space associated with the extended reality display by utilizing an EMG-based gesture input; and
process a command associated with a target object, recognized by virtual the cursor, on the extended reality display.

5. The apparatus of claim 4, wherein the instructions, when executed by the at least one processor, cause the apparatus to map three-dimensional coordinates with respect to a position and orientation of the forearm to the virtual cursor of a virtual ray shape.

6. The apparatus of claim 1, wherein the second wearable device is configured to provide a plurality of different inputs based on a plurality of commands corresponding to a plurality of gestures, wherein each of the plurality of different inputs corresponds to one of the plurality of commands, respectively, and wherein at least one of the plurality of gestures is determined based on the at least one EMG signal.

7. The apparatus of claim 6, wherein the plurality of commands comprises a selection command corresponding to a first gesture of the plurality of gestures, an activation command corresponding to a second gesture of the plurality of gestures, a third command corresponding to a third gesture of the plurality of gestures, a menu command corresponding to a fourth gesture of the plurality of gestures, and a voice recognition command corresponding to a fifth gesture of the plurality of gestures.

8. The apparatus of claim 6, wherein the second wearable device is configured to identify different gestures, among the plurality of gestures, via an EMG signal processing associated with an artificial intelligence model.

9. The apparatus of claim 1, wherein the second wearable device is configured to, based on a type of an object indicated by the virtual cursor, transmit different commands with respect to a same gesture or transmit a same command with respect to different gestures.

10. The apparatus of claim 1, wherein the second wearable device is configured to display a plurality of outputs corresponding to a plurality of inputs on a virtual space associated with the extended reality display.

11. A method performed by an apparatus, the method comprising:
receiving at least one inertial measurement unit (IMU) signal and at least one electromyography (EMG) signal, wherein the at least one IMU signal is generated based on an inertial measurement unit (IMU) sensor, and wherein the at least one EMG signal is generated based on an EMG sensor;
determining, based on the at least one IMU signal, a position of a forearm of a user and an orientation of the forearm;
mapping the determined position and orientation of the forearm to position information of a cursor displayed on a virtual space in a display;
identifying, based on the at least one EMG signal, a gesture of a hand of the user; and
determining, based on the identified gesture, an input associated with an object on the virtual space, wherein the object corresponds to the cursor.

12. The method of claim 11, further comprising:
generating a plurality of objects and the cursor on the virtual space,
wherein the generating the cursor comprises implementing, as the cursor, a virtual ray that is associated with an orientation of the forearm and with a direction of the forearm.

13. The method of claim 12, further comprising identifying the object on the virtual space through a ray-casting technique utilizing the virtual ray.

14. The method of claim 12, further comprising processing a command associated with a target object, identified by the cursor, on the display implementing extended reality.

15. The method of claim 14, wherein the mapping comprises:
determining three-dimensional coordinates with respect to the forearm; and
mapping the three-dimensional coordinates to the cursor implemented as the virtual ray.

16. The method of claim 11, further comprising determining a plurality of different inputs based on a plurality of commands corresponding to a plurality of gestures, wherein each of the plurality of different inputs corresponds to one of the plurality of commands, respectively, and wherein at least one of the plurality of gestures is determined based on the at least one EMG signal.

17. The method of claim 16, wherein the plurality of commands comprises a selection command corresponding to a first gesture of the plurality of gestures, an activation command corresponding to a second gesture of plurality of gestures, a third command corresponding to a third gesture of plurality of gestures, a menu command corresponding to a fourth gesture of plurality of gestures, and a voice recognition command corresponding to a fifth gesture of plurality of gestures.

18. The method of claim 16, further comprising identifying different gestures, among the plurality of gestures, via an EMG signal processing associated with an artificial intelligence model.

19. The method of claim 11, further comprising:
based on a type of an object indicated by the cursor, transmitting different commands with respect to a same gesture or transmitting a same command with respect to different gestures.

20. The method of claim 11, further comprising displaying a plurality of outputs corresponding to a plurality of inputs on the virtual space.
